(19) United States
(12) Patent Application Publication
(10) Pub. No.: US 2019/0277199 A1
(43) Pub. Date: Sep. 12, 2019

(54) TURBO ENGINE, IN PARTICULAR TURBO GENERATOR AND EXCHANGER FOR SUCH TURBO ENGINE

(71) Applicant: TURBOTECH INDUSTRIE, Paris (FR)

(72) Inventor: Damien Fauvet, L'etang La Ville (FR)

(21) Appl. No.: 16/463,157

(22) PCT Filed: Nov. 9, 2017
(86) PCT No.: PCT/FR2017/053060

§ 371 Date: May 22, 2019

(30) Foreign Application Priority Data
Nov. 25, 2016 (FR) 16 61539

(51) Int. Cl. F02C 7/141; F02C 3/06; F02C 7/224; F02C 7/32; F28D 7/16; F28F 9/26

(52) U.S. Cl. CPC F02C 7/141; F02C 3/06; F02C 7/224; F02C 7/32; F28D 2021/0026; F28F 9/26; F05D 2260/204; F28F 2265/26; F28D 7/1676

(57) ABSTRACT

A turbo engine comprising an annular heat exchanger formed by an independent tube assembly assembled by holding means, and having a cylindrical cavity opening on the one hand in the outlet of the turbine, the tube assembly being housed in said cavity. The heat exchanger consists of a first annular bundle and at least one second annular bundle, coaxial with said first annular bundle. An annular closing structure determining an outer annular cavity into which gases from said first tube bundle exit to be deflected on a bottom towards an inner annular cavity, coaxial with the outer annular cavity, opening into the tubes of said second tube bundle.

### BACKGROUND OF THE INVENTION

This invention concerns the field of the production of on-board electrical (or mechanical) energy from fuels for aeronautical, land, sea vehicles and light mobile units by a system coupling a gas turbine to an alternator (electricity production) or to a power shaft (mechanical energy production). In the context of electricity production, more particularly, the invention concerns equipment called “range extenders”.

Applications of the “range extender” type are particularly suitable for the electric motorization of motor vehicles, corresponding to a strong trend, which also extends to aeronautical or maritime vehicles. For applications where the mass, volume and/or cost of batteries are critical, the existing batteries' performance remains insufficient. To fly an electric aircraft with a reasonable range, the mass energy of the most efficient batteries available in 2016 would have to be increased by a factor of 10, while over the past 20 years, the energy embedded in the batteries has only increased by a factor of 2.5.

To overcome this situation, range extenders have been developed to provide the power just needed in cruise mode—or even to disable the operation of the range extender when the power supplied by the batteries is sufficient, and to provide additional power in the transient phases (acceleration, high charge, take-off and climbing of an electric aircraft).

Different technologies have been implemented:
fuel cells whose reliability is not currently sufficient, whose price is very high and whose life span is short,
back-up by photovoltaic cells (for example on the Solar Impulse 2 demonstrator (commercial brand)), a technology that is still too cumbersome and has a very low power-to-weight ratio,
internal combustion engine, or Wankel (trade name) driving a generator, which remains too bulky, and with poor performance.

The most promising autonomy extension solutions are based on the coupling of a micro-turbine equipped with a heat exchanger with an alternator (electric generator).

The use of high-power alternators that are connected to a rotating driven shaft line to provide electrical power is known in the art. The shaft line can, for example, be directly driven by an internal combustion engine. The shaft line can also be driven by the high speed circulation of a fluid such as water vapour or gas. This circulation can be achieved by heating the fluid, for example by using thermal energy or nuclear energy.

To start the rotation of the shaft line, it is known to use the alternator in engine mode by feeding it from a static start frequency converter and an excitation system. The excitation system and converter are powered by a first and second dedicated transformer.

For example, the European patent EP1761736 refers to a micro-turbine motor coupled to an electric generator, comprising:
a compressor providing a compressed air flow;
a recuperator receiving the compressed air flow from the compressor and heating the compressed air flow with the heat of an exhaust gas flow;
a combustion device receiving the heated compressed air flow from the recuperator, mixing the compressed air flow with fuel, and burning the fuel and compressed air mixture to create the exhaust gas flow;
at least one turbine receiving the exhaust gas flow from the combustion device and rotating in response to the exhaust gas flow, the rotation of the at least one turbine driving the compressor; and
an electrical generator generating electricity in response to the rotation of the at least one turbine;
the exhaust gas flowing from the at least one turbine to the recuperator used to heat the compressed air flow;
the recuperator including a plurality of cells, and the flow of compressed air flowing into the internal space of the cells through the inlet manifolds, then through the matrix lamellae, then through the outlet manifolds before flowing to the combustion device, and the flow of exhaust gas flowing through the recuperator and between the cells against the flow of compressed air through the matrix lamellae in the cells.

Patent EP0746680 describes a gas turbine generator unit that includes a rotating unit contained in a circumferential recuperator. The rotating unit consists of a rotor alternator located on a common shaft provided with a turbine wheel and a paddle wheel, supported by double-tested conformable leaf thrust bearings and a conformable leaf radial bearing. The circumferential recuperator comprises a plurality of adjacent openwork sheets provided with bosses to structurally spread the sheets, which are arranged to form flow channels. The recuperator also includes collectors and a structure that allows a differential pressure between each surface of the sheet to be obtained. The circumferential recuperator consists of a unitary structure surrounding the rotating unit and the combustion device in which the incoming air is heated by the recuperator before entering the combustion device. Due to the inter-compatibility and modularity of the components, the air flow path associated with the compressor exhaust side and the turbine intake side is formed during the installation of the rotating unit and recuperator, and by final assembly of the combustion device which forms a terminal enclosure for the turbine intake air.

The U.S. Pat. No. 6,657,332 also refers to a turbo-generator cooling system with a cylindrical heat sink with fins generally extending axially on both the inner and outer sides of a loop section. The loop section is full, except for the holes provided next to the rear end of the section. The stator of the generator is forced into the heat sink until it comes into contact with the internal fins. The generator rotor is equipped with a small fan to send hot air away from the engine intake port. Cooling air flows along the outer fins to the end of the generator. This air flows through the holes in the loop section, passes again between the inside of the loop section and the outside surface of the stator to cool the stator and along a different path to cool the hollow rotor sleeve and permanent magnet rods and the stator.

The U.S. Pat. No. 6,983,787 describing a recovery exhaust gas heat exchanger for a gas turbine engine, a matrix creating a cross flow counterflow around which hot exhaust gas turbine flows, a distribution tube for directing air delivered by a compressor into the matrix/counterflow and a manifold which is arranged parallel to the distribution tube and intended to discharge air from the compressor is heated by the cross flow/counterflow matrix.

In the solutions of the prior art, the structure and operation of the exchanger are not optimized. Plate heat exchanger solutions have a lower weight/efficiency ratio than tube heat exchangers, due to manufacturing and mechanical strength constraints limiting the reduction of plate thickness, in particular.

In the solutions of the previous art, the fuel injection system by spray rods in the combustion and preheating chamber of the turbo engine are two separate devices, multiplying the fuel supply circuits of the combustion chamber.

In the solutions of the previous art, when the electric generator is cooled by air, the cooling circuit is not at the optimum in terms of pressure drop, reducing the overall performance of the entire system.

### SUMMARY OF THE INVENTION

In order to remedy these disadvantages, the invention concerns in its most general sense a turbo engine comprising:
a compressor discharging the compressed gases in a heat exchanger through an annular connection,
an annular combustion chamber, receiving the gases from said exchanger through an annular connection,
a turbine discharging hot gases from the combustion chamber,
a heat exchanger having an annular shape, formed by an independent tube assembly assembled by holding means, and having a cylindrical cavity opening on the one hand into the outlet of the turbine, the tube assembly being housed in said cavity characterized in that said heat exchanger is constituted by:

a) at least one first annular bundle formed by a plurality of a first series of straight tubes, each extending between a proximal perforated connecting plate and a distal perforated connecting plate,
said first annular bundle communicating with said annular connection of the compressor,

b) at least one second annular bundle, coaxial with said first annular bundle, formed by a plurality of a first series of straight tubes, each extending between said proximal perforated connecting plate and said distal perforated connecting plate,
said second annular bundle communicating with said annular connection of the combustion chamber,

c) an annular closing structure determining an outer annular cavity into which gases from said first bundle of tubes open to be deflected on a bottom towards an inner annular cavity, coaxial with the outer annular cavity, opening into the tubes of said second bundle of tubes,

the high-temperature fluid exiting the turbine through said two tube bundles.

According to an advantageous embodiment, said annular connection of the compressor has at least one cylindrical bellows.

According to another embodiment, said annular connection of the combustion chamber has at least one cylindrical bellows.

According to another embodiment, said annular connection between the first bundle of tubes and said annular closing structure includes at least one cylindrical bellows.

According to yet another embodiment, said annular connection between said annular closing structure and the second tube bundle includes at least one cylindrical bellows.

Advantageously, said bellows are constituted by a system of sealed and axially deformable connections allowing the thermal expansion of the tubes of the first and/or second annular sections of the heat exchanger to be made free.

According to a particular variant, the turbo engine according to the invention comprises a fuel supply system for the combustion chamber consisting of at least one fuel spray rod partially surrounded by a heating sleeve.

Preferably, each of said spray rods should incorporate at least one metal filament connected to an electric power supply during the start-up phases to ensure that the fuel is heated up to the point of vaporization inside the spray rods.

According to a first mode of application, the turbine axis directly drives a power shaft.

According to a second mode of application, the turbine axis directly drives an electric generator.

The invention also concerns a turbo generator comprising a turbo engine and an electric generator, characterized in that the axis of the turbine directly drives an electric generator.

Preferably, the turbo generator according to the invention includes an air cooling circuit for the fixed and movable elements of the said electric generator.

Advantageously, the said cooling circuit is composed of two parallel circuits, one to cool the fixed parts, the other the movable parts, with an independent flow calibration system for each air circuit.

The invention also concerns a heat exchanger having an annular shape, formed by an independent tube assembly assembled by holding means, and having a cylindrical cavity opening on the one hand into the outlet of the turbine, the tube assembly being housed in said cavity characterized in that it is constituted by:

a) at least one first annular bundle formed by a plurality of a first series of straight tubes, each extending between a proximal perforated connecting plate and a distal perforated connecting plate,
said first annular bundle communicating with said annular connection of the compressor,

b) at least one second annular bundle, coaxial with said first annular bundle, formed by a plurality of a first series of straight tubes, each extending between said proximal perforated connecting plate and said distal perforated connecting plate,
said second annular bundle communicating with said annular connection of the combustion chamber,

c) an annular closing structure determining an outer annular cavity into which the gases from said first bundle of tubes open to be deflected on a bottom towards an inner annular cavity, coaxial with the outer annular cavity, opening into the tubes of said second bundle of tubes,

the high-temperature fluid exiting the turbine through said two tube bundles.

### BRIEF DESCRIPTION OF THE DRAWINGS

The present invention will be better understood when reading the following detailed description thereof, which relates to a non restrictive exemplary embodiment, while referring to the appended drawings, wherein:

FIG. 1 shows a cross-sectional view of a turbo engine according to the invention,

FIG. 2 shows a perspective view of an example of the annular closing structure,

FIG. 3 shows a detailed cross-sectional view of an example of fuel supply rod,

FIG. 4 shows a detailed cross-sectional view of an example of cooling of the fixed and moving parts of the generator.

### DETAILED DESCRIPTION

The present invention concerns different possible embodiments for the implementation of a turbo generator or for the implementation of a turbo engine for driving a power shaft.

The examples below do not limit the invention to a particular application, and some embodiments can be implemented either in combination on the same equipment or independently on an equipment. In particular, the invention concerns the general objective of optimising a turbo engine, based on an improvement in efficiency resulting from an improved exchanger, as well as an optimisation of the start-up phase by an improved fuel supply rod, and also the optimisation of the cooling of the fixed and movable parts of the generator, when the turbo engine drives a generator.

Description of the Exchanger

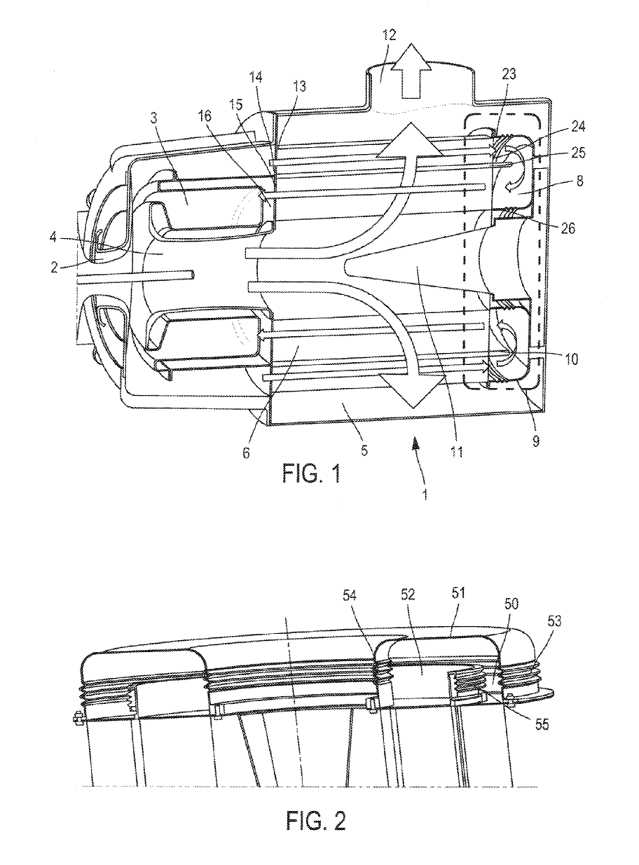

FIG. 1 shows a perspective view of the turbo engine, including an exchanger (1), a compressor (2), a combustion chamber (3) and a turbine (4). A conical deflector (11) coaxial with the exchanger (1) circulates the hot gases from the turbine (4) to an outlet (12) after having passed through the exchanger (2), passing through two cassettes (5, 6) between the tubes.

The parts constituted by the compressor (2), the combustion chamber (3) and the turbine (4) are known to the person skilled in the art and comply with the state of the art of turbo engines.

The exchanger (2) consists of a tube exchanger, comprising two coaxial annular cassettes (5, 6).

The outer cassette (5) consists of an assembly of parallel tubes, made of a high-temperature resistant metal alloy, e.g. 347 refractory stainless steel.

For example, this outer cassette (5) consists of 2000 tubes 300 mm long, with a 2.8 mm inner section and a 3 mm outer section. The tubes are held in a known manner by spacers to define hot gas passages from the turbine.

The tubes form a sleeve with an outer radius of 158 mm and an inner radius of 128 mm.

The inner cassette (6) consists of 2000 tubes 300 mm long, with a 2.8 mm inner section and a 3 mm outer section.

The tubes form a sleeve with an outer radius of 123 millimetres and an inner radius of 67 millimetres.

The two cassettes (5, 6) are coaxial and embedded one in the other.

These two cassettes (5, 6) are joined together at the end opposite the compressor (1) by an annular closing structure (8).

Each of the cassettes (5, 6) has, at each end, a front sealing plate drilled for the passage of the tubes, and ensuring a constant distance between the tubes. The tubes are soldered or welded to ensure watertightness at their connection to the front plates.

This closing structure (8) consists of two nested coaxial parts, generally in the shape of a rum baba mould, made of 2 mm thick 347 refractory stainless steel.

The outer part (9) has an outer section corresponding to the outer section of the outer cassette (5) and an inner section corresponding to the inner section of the inner cassette (6).

The inner part (10) has an outer section corresponding to the inner section of the outer cassette (5) and an inner section corresponding to the outer section of the inner cassette (6).

Each of the parts (9, 10) has a rotation symmetry along the axis of the turbo engine, with a constant longitudinal section.

The closing structure (8) ensures the deflection of gases from the outer cassette (5) to the tubes constituting the inner cassette (6).

This solution ensures a double passage of gases in the exchanger (1), which significantly increases its thermal efficiency for a given space requirement, and in particular a given length.

Description of the Thermal Expansion Bellows

In order to allow relative longitudinal displacement:
between the outer cassette (5) and the inner cassette (6)
   between the outer cassette (5) and the turbo engine frame,
   between the inner cassette (6) and the turbo engine frame,

the connection between the cassettes (5, 6) and the closing structure (8) and/or the annular supply to the combustion chamber (3) and/or the annular outlet of the compressor (2) is provided by deformable areas.

These deformable areas are made up, for example, of metal bellows formed by corrugated sheets of 347 refractory stainless steel.

Different combinations can be used. Of the four pairs of ring-shaped connecting areas (13 to 16; 23 to 26), it is desirable that three be equipped with a deformable ring-shaped connections. It may be sufficient to equip two areas with a deformable connection when the outer cassette (5) has a temperature that does not cause significant expansion.

In the example described in FIG. 2, the closing structure has an annular shape determining an outer annular cavity (50) into which the gases from the first bundle of tubes open to be deflected on a bottom (51) towards an inner annular cavity (52), coaxial with the outer annular cavity (50), opening into the tubes of said second bundle of tubes.

The outer tubular wall of the closing structure has an expansion bellows (53, 54).

Similarly, the partition wall has a bellows (55).

Description of the Supply Rod

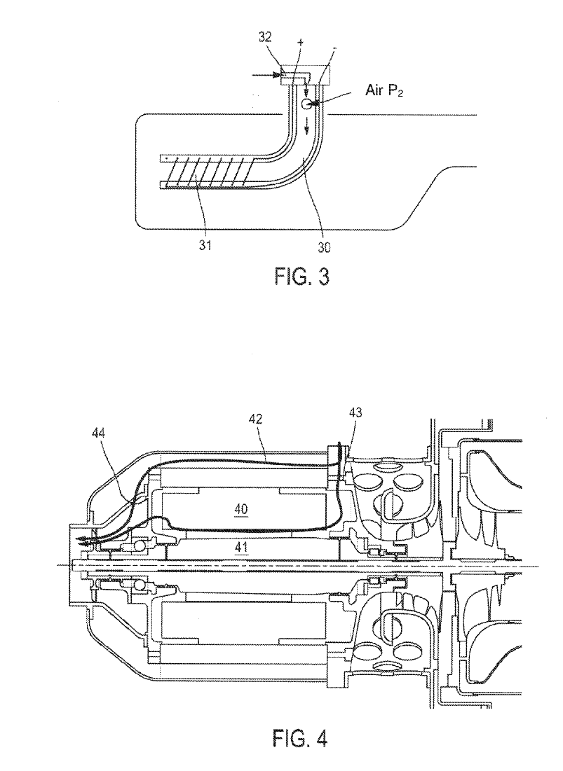

FIG. 3 represents a detailed view of an exemplary embodiment of the spray rod (30). It receives the fuel in liquid form, and includes a fuel supply line (32) and a heating sleeve (31) downstream for vaporizing the fuel. This heating sleeve (31) includes an electrical resistance.

It may also include a nickel coil embedded in a silicon nitride shell.

The outlet of the spray rod (30) can be multiplied to form several injection nozzles. Each of the nozzles can optionally have a heating sleeve.

Description of the Generator Air Cooling System

FIG. 4 is a cross-sectional view of the electric generator, which includes a stator (40) and a rotor (41) in a known manner.

The stator (40) has radial fins at its periphery, through which a flow of fresh air (42) flows. The stator yoke may also have longitudinal holes to ensure fresh air passages.

A second air flow (43) passes through the air gap formed between the stator (40) and the rotor (41).

If necessary, the rotor (41) may have helically shaped twisted teeth to force the air flow through the air gap.

The outlet of these two flows (42, 43) is provided by a front plate (44) located upstream or downstream of the rotor, and having orifices calibrated to balance the flow rate of both flows (42, 43).

The flows (42, 43) enter on one side of the rotor (41) and exit on the other side of the rotor (41) to maximize cooling.

1. A turbo engine comprising:
a compressor discharging compressed gases into a heat exchanger through an annular connection,
an annular combustion chamber receiving the gases from said heat exchanger through an annular connection,
a turbine discharging hot gases from the combustion chamber,
the heat exchanger having an annular shape, formed by an independent tube assembly assembled by holding means, and having a cylindrical cavity opening into a turbine outlet, the tube assembly being housed in said cylindrical cavity, wherein said heat exchanger comprises:
a) at least one first annular bundle formed by a plurality of a first series of straight tubes, each extending between a proximal perforated connecting plate and a distal perforated connecting plate,
said first annular bundle communicating with said annular connection of the compressor,
b) at least one second annular bundle, coaxial with said first annular bundle, formed by a plurality of a first series of straight tubes, each extending between said proximal perforated connecting plate and said distal perforated connecting plate,
said second annular bundle communicating with said annular connection of the combustion chamber,
c) an annular closing structure determining an outer annular cavity communicating with said first tube bundle and an inner annular cavity, coaxial with the outer annular cavity, opening into the tubes of said second tube bundle.

2. The turbo engine according to claim 1 wherein said annular connection of the compressor includes at least one cylindrical bellows.

3. The turbo engine according to claim 1 wherein said annular connection of the combustion chamber includes at least one cylindrical bellows.

4. The turbo engine according to claim 1 wherein said annular connection between the first tube bundle and said annular closing structure comprises at least one cylindrical bellows.

5. The turbo engine according to claim 1 wherein said annular connection between said annular closing structure and the second tube bundle comprises at least one cylindrical bellows.

6. The turbo engine according to claim 1 further comprising a system of sealed and axially deformable connections allowing the thermal expansion of the tubes of the first and second annular sections of the heat exchanger to occur freely.

7. The turbo engine according to claim 1 further comprising a fuel supply system for the combustion chamber consisting of at least one fuel spray rod partially surrounded by a heating sleeve.

8. The turbo engine according to claim 7, wherein said spray rods each incorporate at least one metal filament connected to an electrical supply during the starting phases to ensure the heating of the fuel until the fuel vaporizes inside the spray rods.

9. The turbo engine according to claim 1 wherein the axis of the turbine directly drives a power shaft.

10. engine according to claim 1 wherein the axis of the turbine directly drives an electric generator.

11. A turbo generator comprising the turbo engine according to claim 1 and an electric generator wherein the axis of the turbine directly drives an electric generator.

12. The turbo generator according to claim 11, further comprising an air cooling circuit for the fixed and movable elements of said electric generator.

13. The turbo generator according to claim 12, wherein said cooling circuit is comprises two parallel circuits, one for cooling the fixed elements, the other for cooling the movable elements, with an independent flow calibration system for each air circuit.

14. A heat exchanger having an annular shape, formed by an independent tube assembly assembled by holding means and housed in a cylindrical cavity, comprising:
a) at least one first annular bundle formed by a plurality of a first series of straight tubes, each extending between a proximal perforated connecting plate and a distal perforated connecting plate,
said first annular bundle being in communication with an annular connection,
b) at least one second annular bundle, coaxial with said first annular bundle, formed by a plurality of a first series of straight tubes, each extending between said proximal perforated connecting plate and said distal perforated connecting plate,
said second annular bundle communicating with said annular connection, and
an annular closing structure determining an outer annular cavity into which gases from said first bundle of tubes open to be deflected on a bottom towards an inner annular cavity, coaxial with the outer annular cavity, opening into the tubes of said second bundle of tubes.
